(19) United States
(12) Patent Application Publication
(10) Pub. No.: US 2002/0115021 A1
(43) Pub. Date: Aug. 22, 2002

(54) Configurable patterning device and a method of making integrated circuits using such a device

(75) Inventor: Fan Piao, Fremont, CA (US)

Correspondence Address: Joseph N. Ziebert, FOLEY & LARDNER, Firstar Center, 777 East Wisconsin Avenue, Milwaukee, WI, 53202-5367, US

(73) Assignee: Advanced Micro Devices, Inc.

(21) Appl. No.: 09/775,059

(22) Filed: Feb. 1, 2001

(51) Int. Cl. G03C 5/00

(52) U.S. Cl. 430/311; 430/5; 430/320

(57) ABSTRACT

A lithographic system for an integrated circuit fabrication process includes a computer and a configurable mask. The configurable mask is coupled to the computer. The configurable mask allows light to be transmitted in the pattern controlled by a control signal from the computer. The mask can allow ASIC type functionality for designing custom design integrated circuits.

### FIELD OF THE INVENTION

The present invention relates generally to integrated circuit (IC) fabrication. More particularly, the present invention relates to a reticle or mask and a method of using such a reticle or mask.

### BACKGROUND OF THE INVENTION

Semiconductor fabrication techniques often utilize a mask or reticle. Radiation is provided through or reflected off the mask or reticle to form an image on a semiconductor wafer. The wafer is positioned to receive the radiation transmitted through or reflected off the mask or reticle. The image on the semiconductor wafer corresponds to the pattern on the mask or reticle. The radiation can be light, such as ultraviolet light, vacuum ultraviolet light, etc. The radiation can also be x-ray radiation, e-beam radiation, etc.

Generally, the image is focused on the wafer to pattern a layer of material, such as, photoresist material. The photoresist material can be utilized to define doping regions, deposition regions, etching regions, or other structures associated with an integrated circuit (IC). The photoresist material can also define conductive lines or conductive pads associated with metal layers of an integrated circuit. Further, the photoresist material can define isolation regions, transistor gates, or other transistor structures and elements.

A conventional lithographic system is generally utilized to project the image to the wafer. For example, the conventional lithographic system includes a source of radiation, an optical system, and a reticle or photomask. The source of radiation provides radiation through the optical system and through or off of the mask or reticle.

Generally, a reticle refers to a tool containing a pattern image that is stepped and repeated to expose an entire substrate, such as, a wafer. A photomask or mask refers to a tool which contains patterns that can be transmitted to an entire wafer. However, as used in this application, the terms reticle, photomask, and mask are equivalent unless specifically described otherwise.

A conventional photomask or reticle includes a glass substrate (e.g., fused silica) and an opaque material (e.g., chromium). Several types of glass substrates have been utilized for making photomasks including soda-lime glass, borosilicate glass, and quartz. Photomasks can be positive or negative (clear-field or dark-field tools).

The absorbing material can be chromium, emulsion, and iron oxide which has been deposited upon the glass substrate. According to a conventional mask patterning process, the glass substrate is polished in a multiple step process. The polished substrate is cleaned and inspected for defects. After inspecting the glass substrates, the glass substrates are coated with an opaque material, (e.g., an absorbing layer). The glass substrates can be coated in a sputter deposition process.

The opaque material is selectively etched according to a lithographic process. The opaque material is coated with a resist material. The resist material is patterned via an optical pattern generator. A conventional optical pattern generator utilizes shutters, light sources, optical components, and movable stages to produce the appropriate optical pattern on the resist material. The resist material is then removed in accordance with the optical pattern. The opaque material is removed in accordance with the remaining resist material. The opaque material can be removed by wet etching. Thus, the absorbing material is patterned or etched in accordance with the image desired to be formed on the substrate (e.g., the image provided by the optical pattern generators).

Manufacturing masks and reticles is time consuming and costly. Further, the equipment including the optical pattern generators required to manufacture the masks and reticles is expensive. Masks and reticles must be manufactured for each image to be transferred on the wafer.

A single integrated circuit may require more than 20 to 30 masks. Each of these masks must be mechanically attached to the lithographic system for provision of light to the semiconductor wafer. The transfer and attachments of these masks and reticles is time consuming and can lead to breakage and contamination.

Thus, there is a need for an efficient, inexpensive mask for use in integrated circuit fabrication operations. Further, there is a need for a mask which can be utilized for a variety of process steps in a semiconductor fabrication or integrated circuit fabrication operation. Further still, there is a need for a semiconductor tool which does not require multiple masks. Further still, there is a need for a method of manufacturing integrated circuits which does not require multiple masks.

### SUMMARY OF THE INVENTION

An exemplary embodiment relates to a lithographic system for an integrated circuit fabrication process. The lithographic system includes a computer and a configurable mask or reticle. The configurable mask or reticle is coupled to the computer. The configurable mask or reticle allows light to be transmitted in a pattern controlled by a control signal from the computer.

Another exemplary embodiment relates to method of manufacturing an integrated circuit. The method includes providing a pattern of radiation via an LCD or LED assembly and performing a semiconductor fabrication process in accordance with the pattern of radiation.

Yet another exemplary embodiment relates to a pattern generator for an integrated circuit fabrication system. The pattern generator includes means for providing a pattern of light and means for controlling the means for providing. The means for controlling selects the pattern.

### BRIEF DESCRIPTION OF THE DRAWINGS

Exemplary embodiments will hereafter be described with reference to the accompanying drawings, wherein like numerals denote like elements, and:

FIG. 1 is a general schematic block diagram of an integrated circuit (IC) fabrication system including a configurable mask and a computer system in accordance with an exemplary embodiment;

FIG. 2 is a more detailed general schematic block diagram of the computer system illustrated in FIG. 1;

FIG. 3 is a flow diagram showing a process of manufacturing an integrated circuit utilizing the integrated circuit fabrication system illustrated in FIG. 1in accordance with yet another exemplary embodiment;

FIG. 4 is a flow diagram of showing another process of manufacturing an integrated circuit utilizing the integrated circuit fabrication system illustrated in FIG. 1in accordance with still another exemplary embodiment;

FIG. 5 is a more detailed schematic block diagram of a matrix cell for the configurable mask illustrated in FIG. 1;

FIG. 6 is a general schematic drawing of a pattern provided on the configurable mask illustrated in FIG. 1, the pattern is controlled by the computer system illustrated in FIG. 1;

FIG. 7 is a general schematic block diagram of an integrated circuit (IC) fabrication system including a configurable reticle and a computer system in accordance with another exemplary embodiment; and

FIG. 8 is a more detailed schematic block diagram of a matrix cell for the configurable reticle illustrated in FIG. 7.

### DETAILED DESCRIPTION OF PREFERRED EXEMPLARY EMBODIMENTS

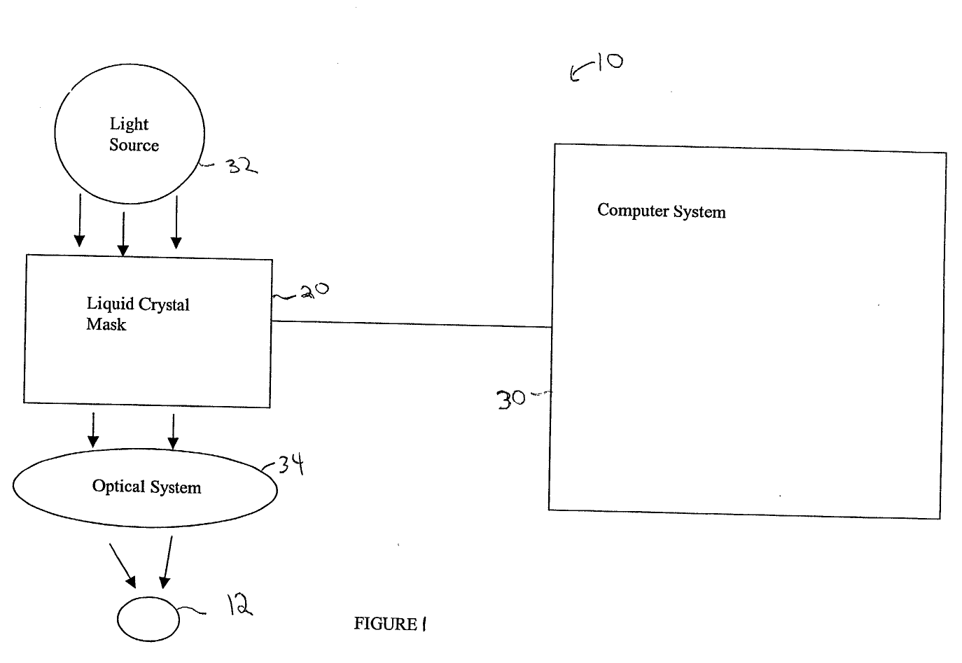

With reference to FIG. 1, an integrated circuit fabrication system 10 is utilized to provide an image to a substrate, such as, a semiconductor or integrated circuit (IC) wafer 12. The image is generally provided as light to wafer 12. The light preferably has a wavelength in the range of 200nm to 700nm. The type of semiconductor process, the type of light, the layer being configured on wafer 12, the type of wafer 12 and the type of equipment are not described below in a limiting fashion.

Wafer 12 can be the substrate for a variety of types of integrated circuits including memory units, logic circuits, communications devices, processors, application specific integrated circuits (ASICs), or other devices. Preferably, wafer 12 is a semiconductor (e.g., silicon) wafer upon which insulative, conductive, and semiconductive materials are deposited in an IC fabrication process.

System 10 can be implemented in a variety of semiconductor tools which utilize lithography. For example, system 10 can be part of a an ultraviolet light stepper unit. System 10 includes a configurable reticle or mask 20 and a computer system 30. System 10 can also include a light source 32 and an optical system 34.

Unlike conventional masks or reticles , mask 20 is configurable. Mask 20 is not limited to a single, fixed image. A single mask 20 can be utilized to generate a multitude of patterns on wafer 12 and layers above wafer 12. Computer system 30 communicates with mask 20 to configure it for a particular image or pattern. Mask 20 can be controlled by a variety of control signals, such as, a video signal, a television signal, an SVGA signal or other signal.

Mask 20 can be embodied as a liquid crystal mask, such as, a liquid crystal shutter, or a liquid crystal display (LCD). Mask 20 can also be embodied as a light emitting diode (LED) matrix, or other electronic assembly capable of providing a pattern to wafer 12. Mask 20, embodied as a liquid crystal shutter or LCD, can include an internal light source, thereby eliminating the need for light source 32. If mask 20 is an LED, light from LED segments can be utilized, thereby eliminating the need for light source 32. Mask 20 and/or light source 32 can provide various spectrums of light to wafer 12. Preferably, source 32 and mask 20 cooperate to provide ultraviolet light to wafer 12.

Mask 20 can include a matrix of cells or shutters or a matrix of LEDs. Preferably, mask 20 is a liquid crystal based matrix controlled electronically by computer system 30. The matrix can be a square-shaped or rectangular array of cells.

Light is provided through mask 20 from light source 32 through optical system 34 to wafer 12. Optical system 34 can include mirrors, lenses, and other apparatus necessary to direct image 34 to wafer 12. Mask 20 can also be a reticle for use in step and repeat processes.

Optical system 34 can include lenses that reduce the image provided to wafer 12. Optical system 34 can have a reduction ratio between 1:1 to 10:1. Preferably, optical system 34 has a reduction ratio of 4:1. Light source 32 can be a 1Amp, such as, a mercury or mercury-vapor lamp. Source 32 can include mirrors, lenses, and other reflective surfaces.

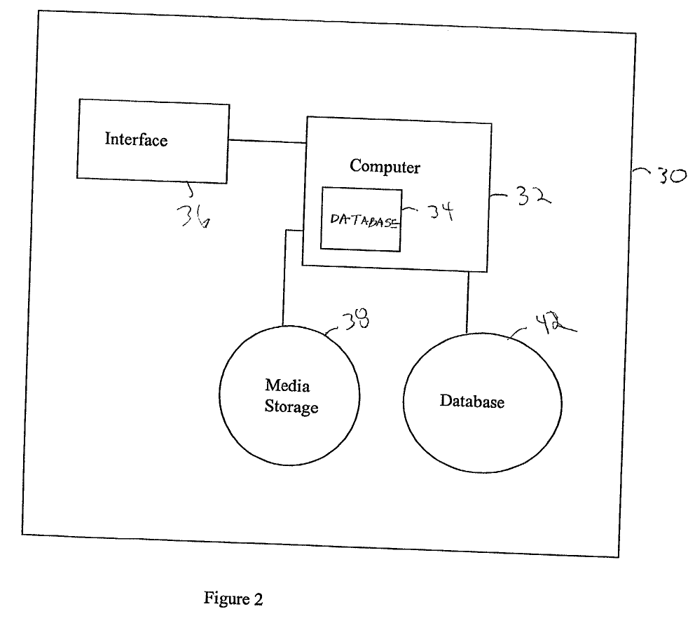

With reference to FIG. 2, computer system 30 can be embodied as a workstation or a personal computer. Computer system 30 can include a processor or computer 32, an internal database 34, a user interface 36, a media storage unit 38, and an external database 42. Computer 32 can be a workstation or personal computer (PC) capable of providing a control signal (video signal, SVGA signal, television signal, etc.) to mask 20. Computer 32 can receive commands from a user via interface 36. Interface 36 can include a keyboard, a display screen, a touch screen, a mouse, a trackball or other devices for displaying and receiving commands.

Computer system 30 can generate the control signal indicative of the image to be transferred to wafer 12. The control signal is generated based upon commands received from interface 36, and from data stored in database 34, media storage unit 38 or database 42. Database 34, unit 38, and database 42 can store representations of graphical images associated with IC structures, such as, transistors, vias, capacitors, pads, conductive lines, etc. Further, databases 34, 42 and unit 38 can store the images for a number of layers to be formed on wafer 12. For example, the layout for metal layers (metal 1, metal 2, metal 3, etc.) can be stored in system 30.

Computer system 30 can advantageously operate to provide ASIC-type functionally (i.e., allowing custom design of individual chips or wafers 12). Such custom designs are not practicable with conventional masks because each mask would have to be individually formed. Thus, system 30 allows IC to be custom designed.

System 10 can provide ASIC-type functionality by selecting parts from database 34, media storage unit 38, or database 42 in accordance with a program to provide images on wafer 12. For example, a software program selecting transistors, diodes and their interconnections can be executed by computer 32 to cause mask 20 to provide the appropriate structures on wafer 12.

The individual images for the individual parts can be stored in database 34, media storage unit 38 or database 42. In this way, computer 32 only operates a minimal software program describing the integrated circuit (IC). Images for individual components are retrieved from unit 38 or database 42 when needed.

In addition, computer system 30, if used in a step and repeat system, can provide custom chips on various parts of the wafer 12. Each chip on wafer 12 can be a separate, distinct design. This feature is particularly valuable as optimum design parameters are being chosen for an IC. Each chip can be designed to test certain design parameters. This separated design for each chip is not possible with a conventional reticle which would have to be changed for each design. Thus, system 10 not only enables custom designs of wafers 12, it enables custom designs of individual chips on wafer 12 if a step and repeat operation is utilized.

Database 34, media storage unit 38 and database 42 can be updated periodically to provide structures for particular processes, technologies, new structures, etc. In this way, updates do not require reformation of fixed masks for revision of the program executed by computer 12 to generate the image on mask 20.

System 10 can be utilized to form a variety of structures on wafer 12. For example, system 10 can be utilized to form metal layers on a partially completed wafer 12. For example, conductive lines or metal layers associated with ASIC-type devices do not require critical line widths. Accordingly, the use of mask 20 can be utilized to print or image features on wafer 12. Other parts of the integrated circuit can be manufactured using conventional masks, if high resolution is necessary.

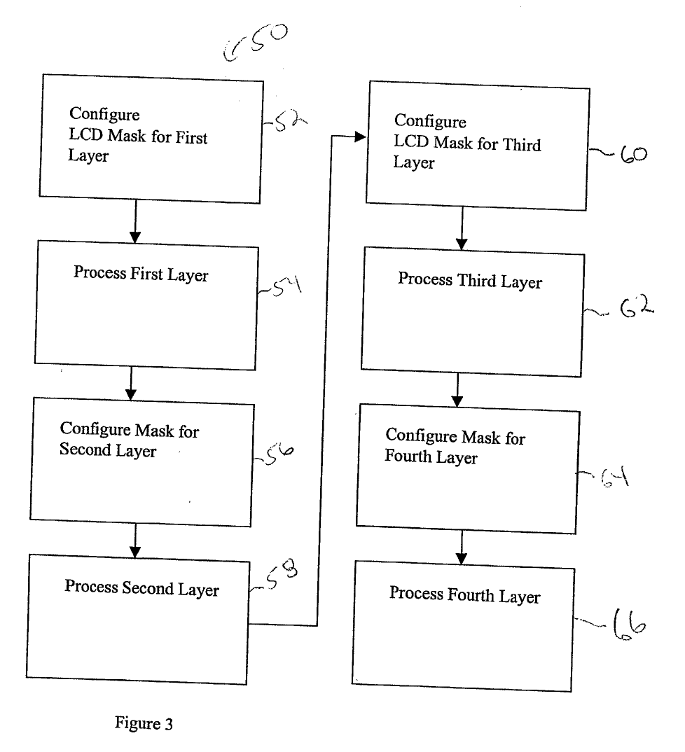

With reference to FIG. 3, a flow diagram 50 showing the operation of system 10 is described. At a step 52, computer system 30 configures mask 20 for a first layer. At a step 54, wafer 12 is processed in accordance with the image provided through mask 20. Step 54 can include patterning of photoresist, etching structures on the wafer, doping structures on the wafer, depositing structures on wafer 12, or a variety of other process steps requiring printing or imaging on wafer 12. At a step 66, after step 54 is completed, mask 20 is reconfigured in accordance with a second image. At a step 58, wafer 12 is subjected to a process in accordance with the second image (similar to step 54).

Similar to steps 52 and 56, computer system 30 configures mask 20 for a third image at a step 60 and processes wafer 12 in accordance with that image at a step 62 (similar to a step 54). At a step 64, computer system 30 configures mask 20 in accordance with another image and wafer 12 is processed in accordance with that image at a step 66 (similar to step 54). tFlow diagram 50 can continue along these lines until the integrated circuits on wafer 12 are completed.

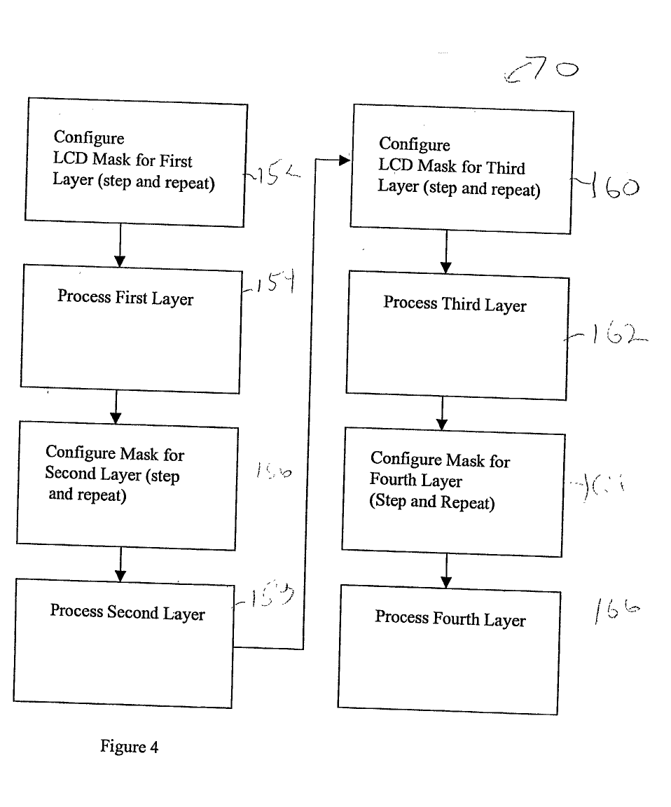

With reference to FIG. 4, a process flow 70 includes a step 152, a step 154, a step 156, a step 158, a step 160, a step 162, a step 164 and a step 166 similar to step 52, step 54, step 56, step 58, step 60, step 62, step 64 and step 66, respectively. (Steps 52, 54, 56, 58, 60, 62, 64 and 66 are discussed with reference to FIG. 3.) However, mask 20 is utilized as a reticle in a step and repeat operation in process flow 70. In such a system, the image is provided to wafer 12 and stepped and repeated to various portions of wafer 12. After stepping and repeating across wafer 12, wafer 12 is processed in accordance with the images provided to wafer 12 at a step 154. Similar step and repeating steps are provided as each time mask 20 is reconfigured at steps 156, 160 and 164.

According to an alternative embodiment, each time a step and repeat is performed, mask 20 can be reconfigured to provide individual integrated circuits on wafer 12. In such a process flow, wafer 12 would be subjected to each process step after the various images were stepped and repeated across the surface of the wafer. With such an embodiment, system 10 allows individual integrated circuit designs to be provided across wafer 12 without requiring masks to be physically changed during the semiconductor processing operation.

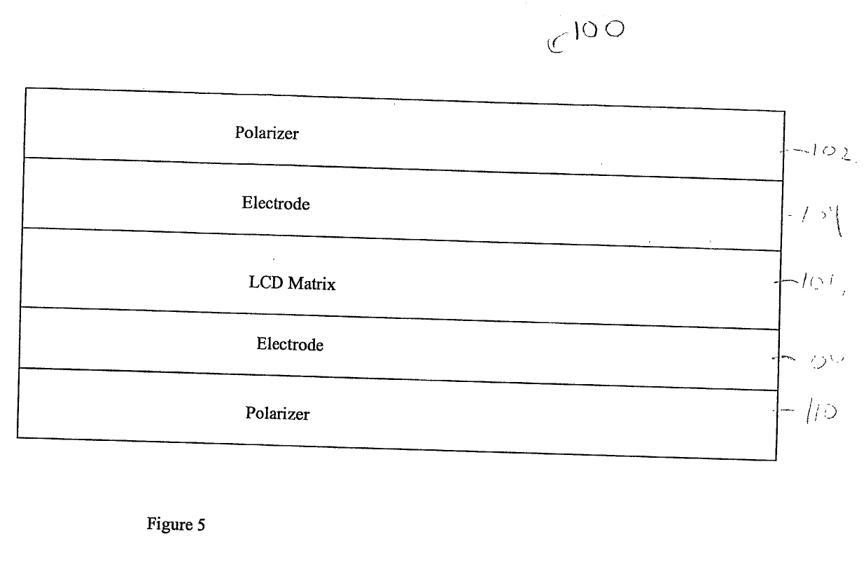

With reference to FIG. 5, an exemplary cell 100, as part of a matrix of cells associated with mask 20 is described below. Cell 100 includes a polarizer 102, an electrode 104, a liquid crystal matrix 106, an electrode 108, and a polarizer 110. In accordance with well-known operational principles associated with liquid crystal displays, electrical signals provided to electrodes 104 and 108 can cause LCD matrix 106 to allow light to pass through cell 100. In one embodiment, cell 100 is capable of transmitting light in multiple colors or a single color. Cell 100 can include filters, lens, compensators, and other optical components.

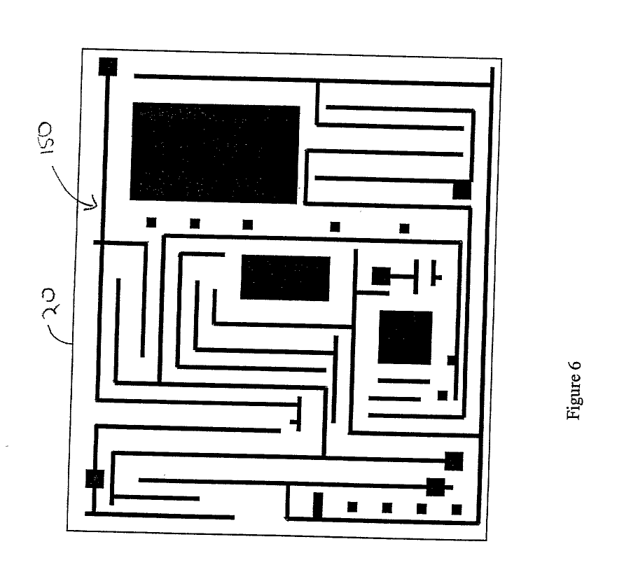

With reference to FIG. 6, mask 20 is configured by a control signal from computer system 30. The control signal can be a VGA signal or SVGA signal or any control signal for configuring mask 20. As shown in FIG. 6, mask 20 includes an image or pattern 150. Image or pattern 150 can be indicative of any of a variety of structures on any of semiconductor layers.

As shown in FIG. 6, image 150 is provided for conductive lines on a metal layer provided on wafer 12. Mask 20 is most usable in situations where resolution associated with image 150 is not extremely demanding. In another area, mask 20 can be utilized to provide large pads for contacts and large power and ground planes for the integrated circuits on wafer 20. In this way, the same mask 20 could be utilized for a variety of chips even though the contact, pad, ground and power plane images are different. Mask 20 would be continued to image the appropriate conductive plane, power plane and ground plane image. Image 150 is shown as an example only.

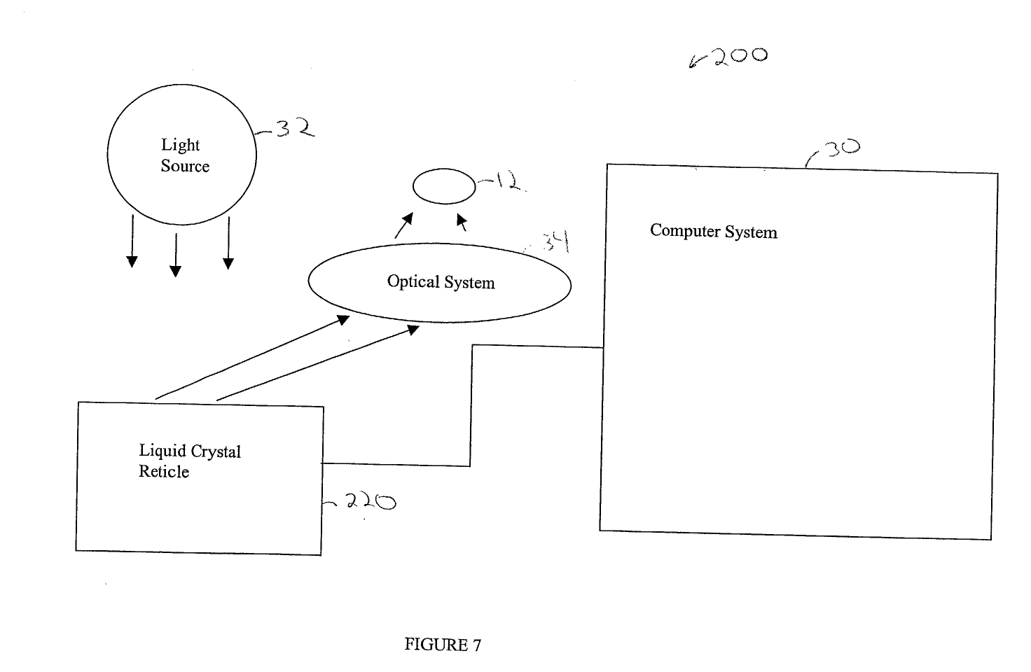

According to an alternative embodiment with reference to FIG. 7, a system 200 can be implemented in a variety of semiconductor tools which utilize lithography. System 200 can be substantially similar to system 10 described with reference to FIG. 1. However, system 200 includes a configurable reticle 220.

Light or radiation from light source 32 is reflected off reticle 220 to optical system 34 and ultimately to wafer 12. Reticle 220 is similar to mask 20 with reference to FIGS. 1-6 and is configured by computer system 30. Preferably, configurable reticle 220 includes a silvered or mirrored surface to reflect light from light source 32.

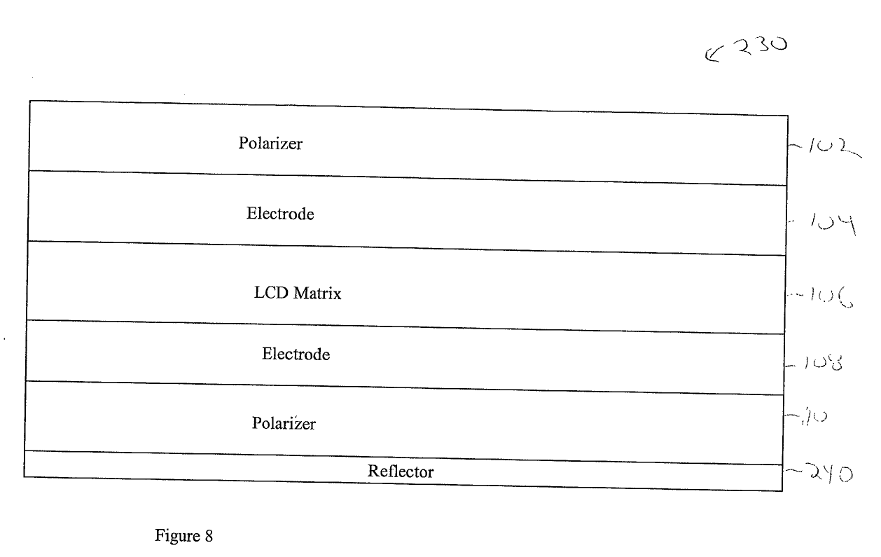

With reference to FIG. 8, an exemplary cell 230, as part of a matrix of cells associated with reticle 220 (FIG. 7)is described below. Cell 230 includes a polarizer 102, an electrode 104, a liquid crystal matrix 106, an electrode 108, a polarizer 110, and a reflector 240. Cell 230 can be similar to cell 100 discussed with reference to FIG. 5. In accordance with well-known operational principles associated with liquid crystal displays, electric signals provided to the electrodes 104 and 108 can cause LCD matrix 106 to allow light to pass through cell 230 to reflector 240 and be reflected back through cell 230 exiting polarizer 102. Cell 230 can include filters, lens, compensators, and other optical components. Reflector 240 can be a silvered or mirrored surface. Alternatively, reflector 240 can be an angled prism for providing reflection at angles above a critical angle. Reflector 240 can be any material or structure for reflecting light though cell 230.

It is understood that while preferred embodiments and specific examples are given, they are for the purpose of illustration only. The present invention is defined by the following claims and is not limited to the precise details disclosed. For example, although specific configurable masks and reticles are discussed, other configurable masks and reticles can be utilized. Further, although a liquid crystal display is discussed, other electronically configurable mask can be utilized. Various modifications may be made in the details within the scope and range of the equivalence of the claims without departing from what is claimed.

What is claimed is:

1. A lithographic system for an integrated circuit fabrication process, the lithographic system comprising:
a computer; and
a configurable mask or reticle coupled to the computer, wherein the configurable mask or reticle allows light to be transmitted in a pattern controlled by a control signal from the computer.

2. The lithographic system of claim 1, wherein the configurable mask or reticle is an LCD or LED matrix.

3. The lithographic system of claim 1 further comprising:
a database for providing image information associated with a device to be patterned on a wafer, the computer using the image information to generate the control signal.

4. The lithographic system of claim 3, wherein the database is stored on a storage media.

5. The lithographic system of claim 3, wherein the image information is related to transistor structures.

6. The lithographic system of claim 1, wherein the control signal is a video signal.

7. A method of manufacturing an integrated circuit, the method comprising:
providing a pattern of radiation via an LCD or LED assembly; and
performing a semiconductor fabrication process in accordance with the pattern of radiation.

8. The method of claim 7, further comprising:
providing a second pattern of radiation via the LCD or LED assembly; and
performing a second semiconductor fabrication process in accordance with the second pattern of radiation.

9. The method of claim 7, wherein the pattern is provided to a wafer in a step and repeat process.

10. The method of claim 7, wherein the pattern is representative of a metal layer associated with the integrated circuit.

11. The method of claim 7, wherein the pattern is representative of a structure associated with a transistor for the integrated circuit.

12. The method of claim 7, wherein a representation of the pattern is stored electronically.

13. The method of claim 7, wherein the integrated circuit is an ASIC.

14. The method of claim 7, wherein the pattern is provided via the LCD assembly.

15. A pattern generator for an integrated circuit fabrication system, the pattern generator comprising: means for providing a pattern of light; and
means for controlling the means for providing, wherein the means for controlling selects the pattern.

16. The pattern generator of claim 15, further comprising:
means for providing a light through the means for providing a pattern.

17. The pattern generator of claim 16, further comprising:
means for focusing the light on a wafer.

18. The pattern generator of claim 15, further comprising:
means for storing elements, wherein the means for controlling creates a control signal representative of the pattern in response to the elements.

19. The pattern generator of claim 15, wherein the means for controlling includes a workstation executing a software program.

20. The pattern generator of claim 19, wherein the means for providing a pattern includes liquid crystals.
